(19) United States
(12) Patent Application Publication
(10) Pub. No.: US 2026/0366650 A1
(43) Pub. Date: Nov. 19, 2026

(54) OIL-WELL METAL PIPE

(71) Applicants: NIPPON STEEL CORPORATION, Tokyo (JP); VALLOUREC OIL AND GAS FRANCE, AULNOYE-AYMERIES (FR)

(72) Inventors: Masahiro OSHIMA, Chiyoda-ku, Tokyo (JP); Tomoya MATSUYAMA, Chiyoda-ku, Tokyo (JP); Hideki MITSUNARI, Chiyoda-ku, Tokyo (JP)

(21) Appl. No.: 19/144,116

(22) PCT Filed: Dec. 19, 2023
(86) PCT No.: PCT/JP2023/045526

§ 371 Date: Jun. 27, 2025

(30) Foreign Application Priority Data
Jan. 17, 2023 (JP) 2023-005115

(51) Int. Cl. F16L 9/02; E21B 17/042; F16L 15/00

(52) U.S. Cl. CPC F16L 9/02; E21B 17/042; F16L 15/007

(57) ABSTRACT

An oil-well metal pipe according to the present disclosure includes a pipe main body including a first end portion and a second end portion. The pipe main body includes a pin formed at the first end portion, and a box formed at the second end portion. The pin includes a pin contact surface which includes an external thread part. The box includes a box contact surface which includes an internal thread part. The oil-well metal pipe further includes: a Zn—Ni alloy plating layer formed on the pin contact surface and/or on the box contact surface, and a zinc phosphate chemical conversion treatment layer in which an orientation index X₀₂₀ of the (020) plane is 2.00 or more formed on the Zn—Ni alloy plating layer.

### TECHNICAL FIELD

The present disclosure relates to a metal pipe, and more particularly relates to an oil-well metal pipe.

### BACKGROUND ART

An oil-well metal pipe is used in oil wells and gas wells (hereinafter, oil wells and gas wells are collectively referred to as simply “oil wells”). An oil-well metal pipe has a threaded connection. Specifically, at the oil well drilling site, in accordance with the depth of the oil well, a plurality of oil-well metal pipes are connected to form an oil country tubular goods connected body as typified by a casing pipe or a tubing pipe. An oil country tubular goods connected body is formed by fastening oil-well steel pipes to each other. Further, inspections may in some cases be conducted on oil country tubular goods connected bodies. When conducting an inspection, the oil country tubular goods connected body is lifted up and loosened. Oil-well metal pipes are then loosened and detached from the oil country tubular goods connected body, and inspected. After the inspection, the oil-well metal pipes are refastened to each other, and the oil-well metal pipes are used again as a part of the oil country tubular goods connected body.

An oil-well metal pipe includes a pin and a box. The pin has a pin contact surface, which includes an external thread part, on an outer peripheral surface of an end portion of the oil-well metal pipe. The box has a box contact surface, which includes an internal thread part, on an inner peripheral surface of an end portion of the oil-well metal pipe. In the present description, the external thread part and the internal thread part are also collectively referred to as “thread parts”. Further, in the present description, the pin contact surface and the box contact surface are also collectively referred to as “contact surfaces”. Note that the pin contact surface may further include a pin unthreaded metal contact portion, which includes a pin sealing surface and a pin shoulder surface. Likewise, the box contact surface may further include a box unthreaded metal contact portion, which includes a box sealing surface and a box shoulder surface.

The pin contact surface and the box contact surface (contact surfaces) of the oil-well metal pipe repeatedly experience strong friction during fastening and loosening. For that reason, galling (uncorrectable seizure) is liable to occur at the contact surfaces when the fastening and loosening are repeated. Accordingly, an oil-well metal pipe is required to have sufficient durability with respect to friction, that is, to have excellent galling resistance.

Technology for enhancing the galling resistance of an oil-well metal pipe is proposed in, for example, International Application Publication No. WO2006/104251 (Patent Literature 1), International Application Publication No. WO2008/108263 (Patent Literature 2), and International Application Publication No. WO2016/170031 (Patent Literature 3).

The oil-well metal pipe disclosed in Patent Literature 1 has a threaded connection, and has a viscous liquid or semisolid lubricant coating on the contact surface of a pin and/or a box, and has a dry solid coating formed thereon. Patent Literature 1 discloses that according to this oil-well metal pipe, the occurrence of rust is suppressed and galling resistance and gastightness are improved.

The oil-well metal pipe disclosed in Patent Literature 2 has a threaded connection, and has a plating layer of Cu alloy selected from the group consisting of Cu—Zn alloy and Cu—Zn-M1 alloy (M1 denotes one or more elements selected from the group consisting of Sn, Bi, and In) on the contact surface of a pin and/or a box. Patent Literature 2 discloses that according to this oil-well metal pipe, the occurrence of crevice corrosion can be prevented and gastightness and galling resistance can be improved.

The oil-well metal pipe disclosed in Patent Literature 3 has a threaded connection, and has a Zn—Ni alloy plating layer on the contact surface of a pin and/or a box. Patent Literature 3 discloses that according to this oil-well metal pipe, corrosion resistance and galling resistance can be improved.

### CITATION LIST

### Patent Literature

Patent Literature 1: International Application Publication No. WO2006/104251
Patent Literature 2: International Application Publication No. WO2008/108263
Patent Literature 3: International Application Publication No. WO2016/170031

### SUMMARY OF INVENTION

### Technical Problem

In this connection, in recent years there is a demand for an oil-well metal pipe which has more excellent galling resistance. In particular, in a large-sized oil-well metal pipe, because the circumference of the pipe main body is longer, sliding over a longer distance is necessary from the start of fastening until the completion of fastening. Consequently, in a large-sized oil-well metal pipe, there is a tendency for galling to occur more easily than in a conventional oil-well metal pipe. Thus, there has been a need for an oil-well metal pipe which has more excellent galling resistance than the conventional oil-well metal pipes.

An objective of the present disclosure is to provide an oil-well metal pipe that has excellent galling resistance.

### Solution to Problem

An oil-well metal pipe according to the present disclosure includes:
a pipe main body including a first end portion and a second end portion, wherein
the pipe main body includes:
a pin formed at the first end portion, and
a box formed at the second end portion;
the pin includes:
a pin contact surface including an external thread part; and
the box includes:
a box contact surface including an internal thread part;
the oil-well metal pipe further including:
a Zn—Ni alloy plating layer formed on the pin contact surface and/or on the box contact surface, and
a zinc phosphate chemical conversion treatment layer formed on the Zn—Ni alloy plating layer;
wherein, in the zinc phosphate chemical conversion treatment layer, an orientation index X₀₂₀ of a (020) plane is 2.00 or more.

### Advantageous Effects of Invention

The oil-well metal pipe according to the present disclosure has excellent galling resistance.

### BRIEF DESCRIPTION OF DRAWINGS

FIG. 1A is a schematic diagram illustrating one part of an image obtained by observing the surface of a zinc phosphate chemical conversion treatment layer in which an orientation index X₀₂₀ of the (020) plane is 2.00 or more.

FIG. 1B is a schematic diagram illustrating one part of an image obtained by observing the surface of a zinc phosphate chemical conversion treatment layer in which an orientation index X₀₂₀ of the (020) plane is less than 2.00.

FIG. 2 is a configuration diagram illustrating one example of an oil-well metal pipe according to the present embodiment.

FIG. 3 is a partial cross-sectional view illustrating a cross section (longitudinal cross section) parallel to a pipe axis direction of a coupling of the oil-well metal pipe illustrated in FIG. 2.

FIG. 4 is a cross-sectional view parallel to the pipe axis direction of the oil-well metal pipe illustrated in FIG. 3, that illustrates a portion in the vicinity of a pin of the oil-well metal pipe.

FIG. 5 is a cross-sectional view parallel to the pipe axis direction of the oil-well metal pipe illustrated in FIG. 3, that illustrates a portion in the vicinity of a box of the oil-well metal pipe.

FIG. 6 is a view illustrating an example of an oil-well metal pipe in which the pin includes an external thread part but does not include a pin sealing surface and a pin shoulder surface, and the box includes an internal thread part but does not include a box sealing surface and a box shoulder surface.

FIG. 7 is a configuration diagram illustrating an integral type oil-well metal pipe according to the present embodiment.

FIG. 8 is a cross-sectional view of the vicinity of a pin contact surface in a case where a Zn—Ni alloy plating layer is formed on the pin contact surface.

FIG. 9 is a cross-sectional view of the vicinity of a box contact surface in a case where a Zn—Ni alloy plating layer is formed on the box contact surface.

FIG. 10 is a cross-sectional view of the vicinity of a pin contact surface having a different structure from that in FIG. 8.

FIG. 11 is a cross-sectional view of the vicinity of a box contact surface having a different structure from that in FIG. 9.

### DESCRIPTION OF EMBODIMENTS

A Zn—Ni alloy plating layer has excellent wear resistance because of the high hardness thereof. Further, by forming a plating layer which has excellent wear resistance, excellent galling resistance tends to be obtained. Therefore, a Zn—Ni alloy plating layer has been applied in oil-well metal pipes in which excellent galling resistance is required. On the other hand, as mentioned above, in a large-sized oil-well metal pipe which has a large diameter, the sliding distance during fastening and loosening is longer than in the case of conventional oil-well metal pipes. Consequently, even amongst oil-well metal pipes which have a Zn—Ni alloy plating layer, in the case of large-sized oil-well metal pipes, excellent galling resistance is not obtained in some cases. Therefore, the present inventors investigated various techniques for increasing the galling resistance of an oil-well metal pipe which has a Zn—Ni alloy plating layer. As a result, the present inventors obtained the following findings.

First, the present inventors investigated forming a lubricant coating at a layer above a Zn—Ni alloy plating layer formed on an oil-well metal pipe. The term “lubricant coating” refers to a layer containing a lubricant, and for example is a solid lubricant coating, or a viscous liquid or semisolid lubricant coating. By forming a lubricant coating at a layer above a Zn—Ni alloy plating layer, there is a possibility that the lubricity between contact surfaces will increase during fastening, and the galling resistance of the oil-well metal pipes will be enhanced.

On the other hand, when oil-well metal pipes are fastened together, high interfacial pressure is applied to the contact surfaces. Consequently, in a case where fastening and loosening are repeatedly performed, there is a possibility that the lubricant coating may peel off. In other words, there is a possibility that, by increasing the adhesion of a lubricant coating, peeling of the lubricant coating can be suppressed even when fastening and loosening are repeated. Therefore, there is a possibility that the galling resistance of the oil-well metal pipe will increase. Thus the present inventors thought of forming a chemical conversion treatment layer between the Zn—Ni alloy plating layer and the lubricant coating to increase the adhesion of the lubricant coating.

Specifically, among chemical conversion treatment layers, the present inventors focused on a zinc phosphate chemical conversion treatment layer. Even among chemical conversion treatment layers, the grains of a zinc phosphate chemical conversion treatment layer tend to become coarse, and the surface roughness thereof tends to be high. Therefore, the present inventors conducted more detailed studies regarding a zinc phosphate chemical conversion treatment layer to be formed on a Zn—Ni alloy plating layer. As a result, the present inventors clarified that the orientation of a zinc phosphate chemical conversion treatment layer influences the galling resistance of an oil-well metal pipe.

Here, in the present description, the distribution state of the crystal orientations in a zinc phosphate chemical conversion treatment layer is also referred to as “orientation of a zinc phosphate chemical conversion treatment layer”. Further, X-ray diffraction analysis (XRD) is available as a technique for evaluating the orientation of a material. In XRD, diffraction that occurs as a result of scattering and interference of X-rays caused by electrons surrounding atoms is analyzed. Therefore, in XRD, a distinctive diffraction pattern is obtained for each atomic arrangement in the material. In other words, the size of crystals and the orientation of a material can be evaluated based on a diffraction pattern obtained by XRD.

As a result of detailed studies conducted by the present inventors, it was clarified that in a zinc phosphate chemical conversion treatment layer, if an orientation index X₀₂₀ of the (020) plane is 2.00 or more, unevenness of the surface of the zinc phosphate chemical conversion treatment layer markedly increases, and the adhesion of a lubricant coating increases, and as a result, the galling resistance of the oil-well metal pipe increases. Here, the term “orientation index” refers to an index that indicates to what extent a specific plane is preferentially oriented in comparison to non-oriented zinc phosphate polycrystalline powder. That is, when the orientation index X₀₂₀ of the (020) plane of a zinc phosphate chemical conversion treatment layer is 2.00 or more, it means that the (020) plane is preferentially oriented by a multiple of 2.00 or more compared to non-oriented zinc phosphate polycrystalline powder.

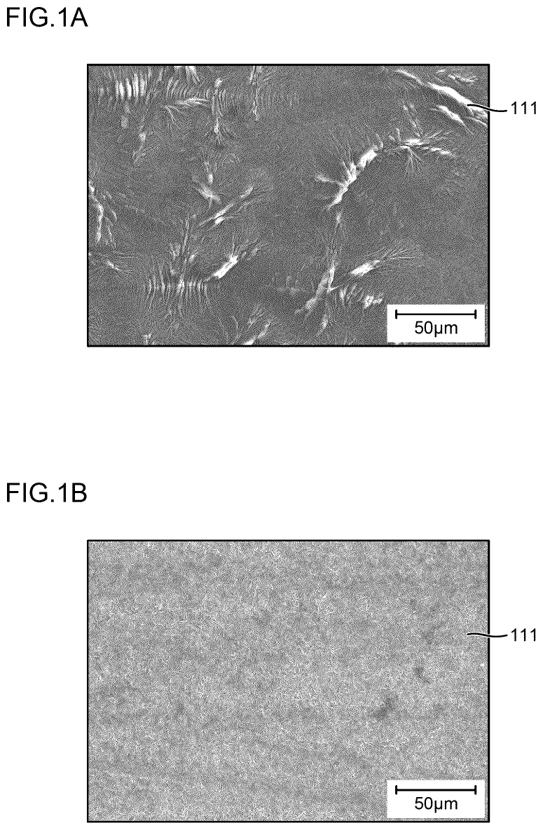

Further, as a result of detailed studies conducted by the present inventors, it was clarified that if the orientation index X₀₂₀ of the (020) plane is 2.00 or more, the unevenness on the surface of the zinc phosphate chemical conversion treatment layer is markedly different. This point will be described in detail using the drawings. FIG. 1A is a schematic diagram illustrating one part of an image obtained by observing the surface of a zinc phosphate chemical conversion treatment layer in which the orientation index X₀₂₀ of the (020) plane is 2.00 or more. FIG. 1B is a schematic diagram illustrating one part of an image obtained by observing the surface of a zinc phosphate chemical conversion treatment layer in which the orientation index X₀₂₀ of the (020) plane is less than 2.00. FIG. 1A and FIG. 1B are each a secondary electron image obtained using a scanning electron microscope (SEM). The magnification of the SEM observation was set to ×500. Further, FIG. 1A shows a SEM image obtained by observing an oil-well metal pipe of Test Number 1 of Examples that are described later. Similarly, FIG. 1B shows a SEM image obtained by observing an oil-well metal pipe of Test Number 2 of Examples that are described later.

In FIG. 1A, white-colored regions are zinc phosphate crystals 111. That is, referring to FIG. 1A, in the zinc phosphate chemical conversion treatment layer in which the orientation index X₀₂₀ is 2.00 or more, a state in which the zinc phosphate crystals 111 are locally unevenly distributed can be confirmed. On the other hand, referring to FIG. 1B, in the zinc phosphate chemical conversion treatment layer in which the orientation index X₀₂₀ is less than 2.00, uneven distribution of the zinc phosphate crystals 111 as is seen in FIG. 1A cannot be confirmed. That is, it can be confirmed that in the zinc phosphate chemical conversion treatment layer in which the orientation index X₀₂₀ is 2.00 or more as illustrated in FIG. 1A, the unevenness of the surface markedly increases.

Accordingly, in the oil-well metal pipe according to the present embodiment, a zinc phosphate chemical conversion treatment layer in which the orientation index X₀₂₀ is 2.00 or more is formed on a Zn—Ni alloy plating layer. As a result, in a case where a lubricant coating is formed at a layer on the zinc phosphate chemical conversion treatment layer, the adhesion of the lubricant coating increases and the galling resistance of the oil-well metal pipe can be enhanced.

The gist of the oil-well metal pipe according to the present embodiment which was completed based on the above findings is as follows.

[1]

An oil-well metal pipe, including:
a pipe main body including a first end portion and a second end portion, wherein:
the pipe main body includes:
a pin formed at the first end portion, and
a box formed at the second end portion;
the pin includes:
a pin contact surface including an external thread part; and
the box includes:
a box contact surface including an internal thread part;
the oil-well metal pipe further including:
a Zn—Ni alloy plating layer formed on the pin contact surface and/or on the box contact surface, and
a zinc phosphate chemical conversion treatment layer formed on the Zn—Ni alloy plating layer;
wherein, in the zinc phosphate chemical conversion treatment layer, an orientation index X₀₂₀ of a (020) plane is 2.00 or more.
   [2]

The oil-well metal pipe according to [1], including:
a lubricant coating on the zinc phosphate chemical conversion treatment layer.

Hereunder, the oil-well metal pipe according to the present embodiment is described in detail.

### [Structure of Oil-Well Metal Pipe]

First, the structure of the oil-well metal pipe of the present embodiment will be described. The oil-well metal pipe has a well-known structure. The available types of oil-well metal pipe are a T&C type oil-well metal pipe and an integral type oil-well metal pipe. Hereunder, each type of oil-well metal pipe is described in detail.

[Case where Oil-Well Metal Pipe 1 is T&C Type]

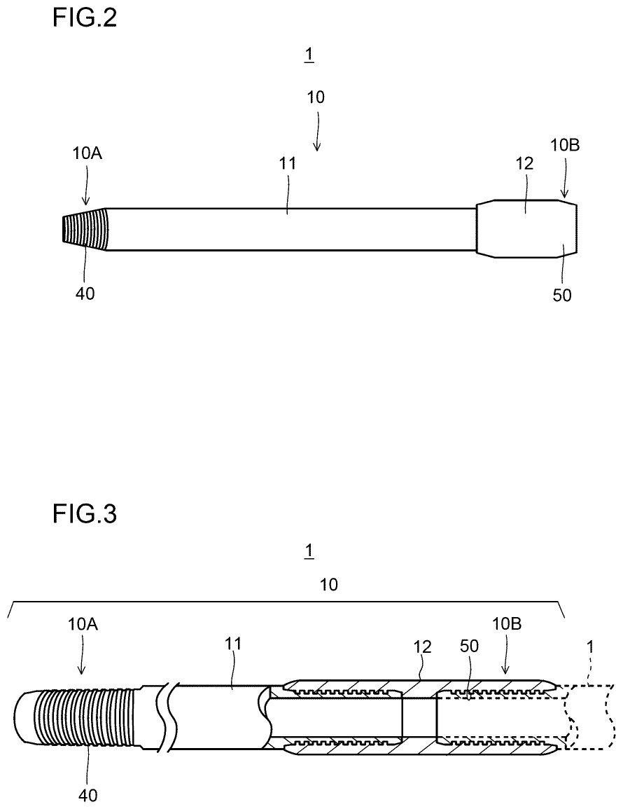

FIG. 2 is a configuration diagram illustrating one example of an oil-well metal pipe 1 according to the present embodiment. FIG. 2 is a configuration diagram illustrating the oil-well metal pipe 1 of a so-called “T&C (threaded and coupled) type”. Referring to FIG. 2, the oil-well metal pipe 1 includes a pipe main body 10.

The pipe main body 10 extends in the pipe axis direction. A cross section perpendicular to the pipe axis direction of the pipe main body 10 is a circular shape. The pipe main body 10 includes a first end portion 10A and a second end portion 10B. The first end portion 10A is an end portion on the opposite side to the second end portion 10B. In the T&C type oil-well metal pipe 1 illustrated in FIG. 2, the pipe main body 10 includes a pin tube body 11 and a coupling 12. The coupling 12 is attached to one end of the pin tube body 11. More specifically, the coupling 12 is fastened by threading to one end of the pin tube body 11.

FIG. 3 is a partial cross-sectional view illustrating a cross section (longitudinal cross section) that is parallel to the pipe axis direction of the coupling 12 of the oil-well metal pipe 1 illustrated in FIG. 2. Referring to FIG. 2 and FIG. 3, the pipe main body 10 includes a pin 40 and a box 50. The pin 40 is formed at the first end portion 10A of the pipe main body 10. When performing fastening, the pin 40 is inserted into the box 50 of another oil-well metal pipe 1 (not illustrated), and is fastened by threading to the box 50 of the other oil-well metal pipe 1.

The box 50 is formed at the second end portion 10B of the pipe main body 10. When performing fastening, the pin 40 of another oil-well metal pipe 1 is inserted into the box 50, and the box 50 is fastened by threading to the pin 40 of the other oil-well metal pipe 1.

### [Regarding Structure of Pin 40]

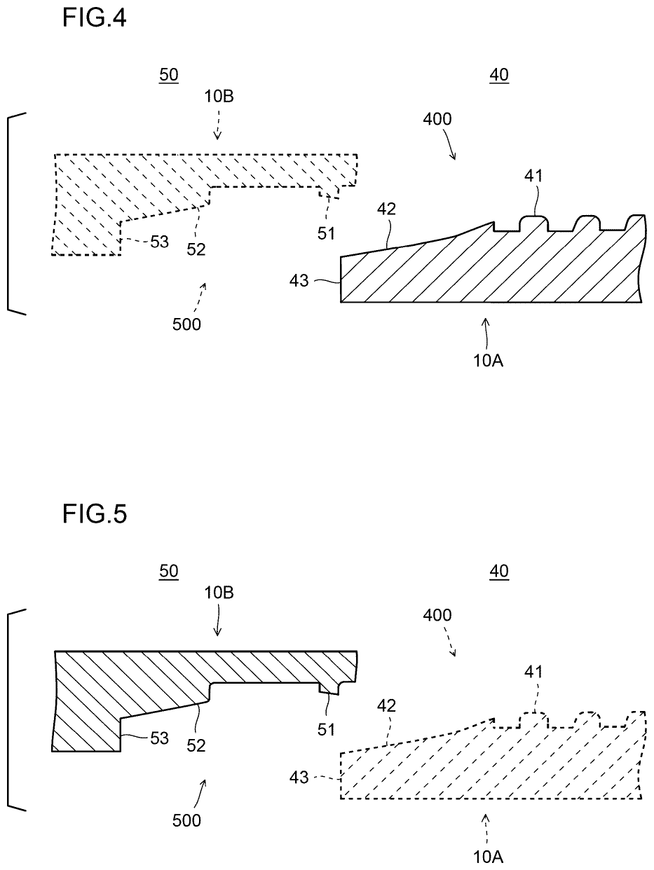

FIG. 4 is a cross-sectional view of a portion in the vicinity of the pin 40 of the oil-well metal pipe 1 illustrated in FIG. 3, that is a cross-sectional view parallel to the pipe axis direction of the oil-well metal pipe 1. A dashed line portion in FIG. 4 represents the structure of the box 50 of another oil-well metal pipe in the case of fastening the oil-well metal pipe 1 to another oil-well metal pipe 1. Referring to FIG. 4, the pin 40 includes a pin contact surface 400 on the outer peripheral surface of the first end portion 10A of the pipe main body 10. When fastening to the other oil-well metal pipe 1, the pin contact surface 400 is screwed into the box 50 of the other oil-well metal pipe 1 and contacts a box contact surface 500 (described later) of the box 50.

The pin contact surface 400 includes at least an external thread part 41 formed in the outer peripheral surface of the first end portion 10A. The pin contact surface 400 may further include a pin sealing surface 42 and a pin shoulder surface 43. In FIG. 4, the pin shoulder surface 43 is disposed at the front end face of the first end portion 10A, and on the outer peripheral surface of the first end portion 10A, the pin sealing surface 42 is disposed further on the front end side of the first end portion 10A than the external thread part 41. In other words, the pin sealing surface 42 is disposed between the external thread part 41 and the pin shoulder surface 43. The pin sealing surface 42 is provided in a tapered shape. Specifically, the external diameter of the pin sealing surface 42 gradually decreases from the external thread part 41 toward the pin shoulder surface 43 in the longitudinal direction (pipe axis direction) of the first end portion 10A.

When performing fastening with another oil-well metal pipe 1, the pin sealing surface 42 contacts a box sealing surface 52 (described later) of the box 50 of the other oil-well metal pipe 1. More specifically, during fastening, when the pin 40 is inserted into the box 50 of the other oil-well metal pipe 1, the pin sealing surface 42 contacts the box sealing surface 52. Subsequently, when the pin 40 is screwed further into the box 50 of the other oil-well metal pipe 1, the pin sealing surface 42 closely contacts the box sealing surface 52. By this means, during fastening, the pin sealing surface 42 closely contacts the box sealing surface 52 to thereby form a seal that is based on metal-to-metal contact. Therefore, the gastightness can be increased in each of the oil-well metal pipes 1 that are fastened to each other.

In FIG. 4, the pin shoulder surface 43 is disposed at the front end face of the first end portion 10A. In other words, in the pin 40 illustrated in FIG. 4, the external thread part 41, the pin sealing surface 42 and the pin shoulder surface 43 are disposed sequentially in that order from the center of the pipe main body 10 toward the first end portion 10A. During fastening to another oil-well metal pipe 1, the pin shoulder surface 43 opposes and contacts a box shoulder surface 53 (described later) of the box 50 of the other oil-well metal pipe 1. More specifically, during fastening, the pin shoulder surface 43 contacts the box shoulder surface 53 as a result of the pin 40 being inserted into the box 50 of the other oil-well metal pipe 1. By this means, during fastening, a high torque can be obtained. Further, the positional relation between the pin 40 and the box 50 in the fastening state can be stabilized.

Note that, the pin contact surface 400 of the pin 40 includes at least the external thread part 41. In other words, the pin contact surface 400 may include the external thread part 41, and need not include the pin sealing surface 42 and the pin shoulder surface 43. The pin contact surface 400 may include the external thread part 41 and the pin shoulder surface 43, and need not include the pin sealing surface 42. The pin contact surface 400 may include the external thread part 41 and the pin sealing surface 42, and need not include the pin shoulder surface 43.

### [Regarding Structure of Box 50]

FIG. 5 is a cross-sectional view of a portion in the vicinity of the box 50 of the oil-well metal pipe 1 illustrated in FIG. 3, that is a cross-sectional view parallel to the pipe axis direction of the oil-well metal pipe 1. A dashed line portion in FIG. 5 represents the structure of the pin 40 of another oil-well metal pipe 1 in the case of fastening the oil-well metal pipe 1 to another oil-well metal pipe 1. Referring to FIG. 5, the box 50 includes a box contact surface 500 on the inner peripheral surface of the second end portion 10B of the pipe main body 10. When performing fastening to another oil-well metal pipe 1, the box contact surface 500 contacts the pin contact surface 400 of the pin 40 of the other oil-well metal pipe 1 when the pin 40 is screwed into the box 50.

The box contact surface 500 includes at least an internal thread part 51 formed in the inner peripheral surface of the second end portion 10B. When performing fastening, the internal thread part 51 engages with the external thread part 41 of the pin 40 of the other oil-well metal pipe 1.

The box contact surface 500 may further include the box sealing surface 52 and the box shoulder surface 53. In FIG. 5, on the inner peripheral surface of the second end portion 10B, the box sealing surface 52 is disposed further on the pipe main body 10 side than the internal thread part 51. In other words, the box sealing surface 52 is disposed between the internal thread part 51 and the box shoulder surface 53. The box sealing surface 52 is provided in a tapered shape. Specifically, the internal diameter of the box sealing surface 52 gradually decreases from the internal thread part 51 toward the box shoulder surface 53 in the longitudinal direction (pipe axis direction) of the second end portion 10B.

When performing fastening to another oil-well metal pipe 1, the box sealing surface 52 contacts the pin sealing surface 42 of the pin 40 of the other oil-well metal pipe 1. More specifically, during fastening, when the pin 40 of the other oil-well metal pipe 1 is screwed into the box 50, the box sealing surface 52 contacts the pin sealing surface 42, and when the pin 40 is screwed in further, the box sealing surface 52 closely contacts the pin sealing surface 42. By this means, during fastening, the box sealing surface 52 closely contacts the pin sealing surface 42 to thereby form a seal that is based on metal-to-metal contact. Therefore, the gastightness can be increased in each of the oil-well metal pipes 1 that are fastened to each other.

The box shoulder surface 53 is disposed further on the pipe main body 10 side than the box sealing surface 52. In other words, in the box 50, the box shoulder surface 53, the box sealing surface 52 and the internal thread part 51 are disposed sequentially in that order from the center of the pipe main body 10 toward the front end of the second end portion 10B. When performing fastening to another oil-well metal pipe 1, the box shoulder surface 53 opposes and contacts the pin shoulder surface 43 of the pin 40 of the other oil-well metal pipe 1. More specifically, during fastening, the box shoulder surface 53 contacts the pin shoulder surface 43 as a result of the pin 40 of the other oil-well metal pipe 1 being inserted into the box 50. By this means, during fastening, a high torque can be obtained. Further, the positional relation between the pin 40 and the box 50 in the fastening state can be stabilized.

The box contact surface 500 includes at least the internal thread part 51. When performing fastening, the internal thread part 51 of the box contact surface 500 of the box 50 contacts the external thread part 41 of the pin contact surface 400 of the pin 40 in a manner such that the internal thread part 51 corresponds with the external thread part 41. The box sealing surface 52 contacts the pin sealing surface 42 in a manner such that the box sealing surface 52 corresponds with the pin sealing surface 42. The box shoulder surface 53 contacts the pin shoulder surface 43 in a manner such that the box shoulder surface 53 corresponds with the pin shoulder surface 43.

In a case where the pin contact surface 400 includes the external thread part 41 and does not include the pin sealing surface 42 and the pin shoulder surface 43, the box contact surface 500 includes the internal thread part 51 and does not include the box sealing surface 52 and the box shoulder surface 53. In a case where the pin contact surface 400 includes the external thread part 41 and the pin shoulder surface 43 and does not include the pin sealing surface 42, the box contact surface 500 includes the internal thread part 51 and the box shoulder surface 53 and does not include the box sealing surface 52. In a case where the pin contact surface 400 includes the external thread part 41 and the pin sealing surface 42 and does not include the pin shoulder surface 43, the box contact surface 500 includes the internal thread part 51 and the box sealing surface 52 and does not include the box shoulder surface 53.

The pin contact surface 400 may include a plurality of the external thread parts 41, may include a plurality of the pin sealing surfaces 42, and may include a plurality of the pin shoulder surfaces 43. For example, the pin shoulder surface 43, the pin sealing surface 42, the external thread part 41, the pin sealing surface 42, the pin shoulder surface 43, the pin sealing surface 42 and the external thread part 41 may be disposed in that order on the pin contact surface 400 of the pin 40 from the front end of the first end portion 10A toward the center of the pipe main body 10. In such case, the internal thread part 51, the box sealing surface 52, the box shoulder surface 53, the box sealing surface 52, the internal thread part 51, the box sealing surface 52 and the box shoulder surface 53 are disposed in that order on the box contact surface 500 of the box 50 from the front end of the second end portion 10B toward the center of the pipe main body 10.

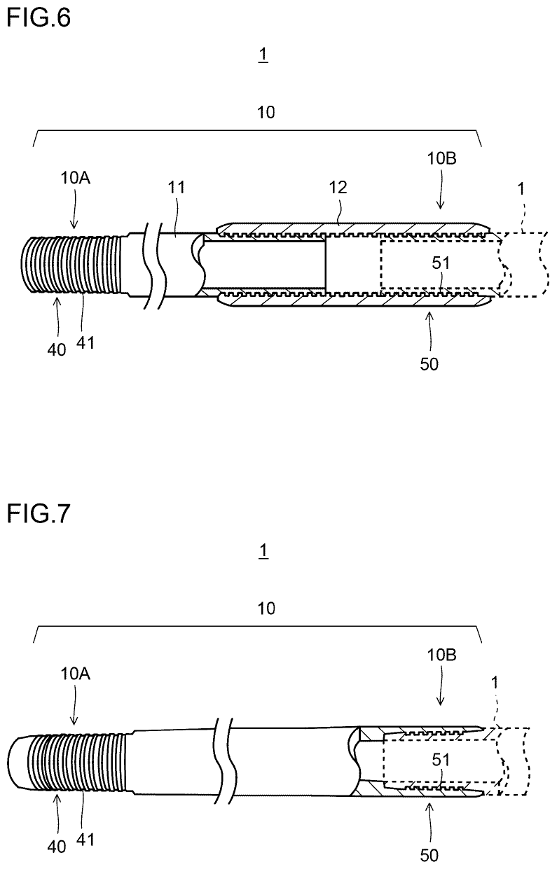

In FIG. 4 and FIG. 5, a so-called “premium joint” is illustrated in which the pin 40 includes the external thread part 41, the pin sealing surface 42 and the pin shoulder surface 43, and the box 50 includes the internal thread part 51, the box sealing surface 52 and the box shoulder surface 53. However, as described above, the pin 40 may include the external thread part 41 and need not include the pin sealing surface 42 and the pin shoulder surface 43. In this case, the box 50 includes the internal thread part 51 and does not include the box sealing surface 52 and the box shoulder surface 53. FIG. 6 is a view illustrating one example of the oil-well metal pipe 1 in which the pin 40 includes the external thread part 41 and does not include the pin sealing surface 42 and the pin shoulder surface 43, and the box 50 includes the internal thread part 51 and does not include the box sealing surface 52 and the box shoulder surface 53.

[Case where Oil-Well Metal Pipe 1 is Integral Type]

The oil-well metal pipe 1 illustrated in FIG. 2, FIG. 3 and FIG. 6 is a so-called “T&C type” oil-well metal pipe 1, in which the pipe main body 10 includes the pin tube body 11 and the coupling 12. However, the oil-well metal pipe 1 according to the present embodiment may be an integral type instead of a T&C type.

FIG. 7 is a configuration diagram of an integral type oil-well metal pipe 1 according to the present embodiment. Referring to FIG. 7, the integral type oil-well metal pipe 1 includes a pipe main body 10. The pipe main body 10 includes a first end portion 10A and a second end portion 10B. The first end portion 10A is disposed on the opposite side to the second end portion 10B. As described above, in the T&C type oil-well metal pipe 1, the pipe main body 10 includes the pin tube body 11 and the coupling 12. In other words, in the T&C type oil-well metal pipe 1, the pipe main body 10 is constituted by fastening two separate members (the pin tube body 11 and the coupling 12). In contrast, in the integral type oil-well metal pipe 1, the pipe main body 10 is formed in an integral manner.

The pin 40 is formed at the first end portion 10A of the pipe main body 10. When performing fastening, the pin 40 is inserted in and screwed into the box 50 of another integral type oil-well metal pipe 1, and thereby fastened to the box 50 of the other integral type oil-well metal pipe 1. The box 50 is formed at the second end portion 10B of the pipe main body 10. When performing fastening, the pin 40 of another integral type oil-well metal pipe 1 is inserted in and screwed into the box 50, to thereby fasten the box 50 to the pin 40 of the other integral type oil-well metal pipe 1.

The structure of the pin 40 of the integral type oil-well metal pipe 1 is the same as the structure of the pin 40 of the T&C type oil-well metal pipe 1 illustrated in FIG. 4. Similarly, the structure of the box 50 of the integral type oil-well metal pipe 1 is the same as the structure of the box 50 of the T&C type oil-well metal pipe 1 illustrated in FIG. 5. Note that, in FIG. 4 and FIG. 5, the pin shoulder surface 43, the pin sealing surface 42 and the external thread part 41 in the pin 40 are disposed in that order from the front end of the first end portion 10A toward the center of the pipe main body 10. Therefore, the internal thread part 51, the box sealing surface 52 and the box shoulder surface 53 in the box 50 are disposed in that order from the front end of the second end portion 10B toward the center of the pipe main body 10. However, similarly to the pin contact surface 400 of the pin 40 of the T&C type oil-well metal pipe 1, it suffices that the pin contact surface 400 of the pin 40 of the integral type oil-well metal pipe 1 includes at least the external thread part 41. Further, similarly to the box contact surface 500 of the box 50 of the T&C type oil-well metal pipe 1, it suffices that the box contact surface 500 of the box 50 of the integral type oil-well metal pipe 1 includes at least the internal thread part 51.

In short, the oil-well metal pipe 1 according to the present embodiment may be a T&C type or may be an integral type.

### [Chemical Composition of Pipe Main Body]

The chemical composition of the pipe main body 10 of the oil-well metal pipe 1 according to the present embodiment is not particularly limited. That is, in the present embodiment, the type of steel of the pipe main body 10 of the oil-well metal pipe 1 is not particularly limited. The pipe main body 10 may be formed of, for example, carbon steel, stainless steel, an alloy, or the like. That is, the oil-well metal pipe 1 may be a pipe made of an Fe-based alloy, or may be an alloy pipe as typified by a Ni-based alloy pipe. Here, examples of the steel pipe include a low-alloy steel pipe, a martensitic stainless steel pipe, a ferritic stainless steel pipe, an austenitic stainless steel pipe, and a duplex stainless steel pipe. Examples of the alloy pipe include a Ni-based alloy pipe and a NiCrFe alloy pipe.

Here, among alloys, so-called “high alloys” such as Ni-based alloys and duplex stainless steels that contain alloying elements such as Cr, Ni and Mo have high corrosion resistance. Therefore, when these high alloys are used as the pipe main body 10, excellent corrosion resistance will be obtained in a corrosive environment that contains hydrogen sulfide or carbon dioxide or the like. In addition, the pipe main body 10 may be formed with a plating layer on the surface. The pipe main body 10 may be, for example, a carbon steel with a plating layer, a stainless steel with a plating layer, or an alloy steel with a plating layer. In this case, a plating layer may be, for example, a Ni plating layer, a Cu plating layer, or a Cr plating layer. Thus, the pipe main body 10 according to the present embodiment is not particularly limited if the pipe main body 10 has the required performance as an oil-well metal pipe.

### [Zn—Ni Alloy Plating Layer]

In the oil-well metal pipe 1 according to the present embodiment, a Zn—Ni alloy plating layer is formed on at least one contact surface among the pin contact surface 400 and the box contact surface 500. In other words, the Zn—Ni alloy plating layer may be formed on the pin contact surface 400, and need not be formed on the box contact surface 500. Alternatively, the Zn—Ni alloy plating layer may be formed on the box contact surface 500, and need not be formed on the pin contact surface 400. Further, the Zn—Ni alloy plating layer may be formed on the pin contact surface 400 and on the box contact surface 500.

### [Composition of Zn—Ni Alloy Plating Layer]

The Zn—Ni alloy plating layer 100 is composed of a Zn—Ni alloy. Specifically, the Zn—Ni alloy contains zinc (Zn) and nickel (Ni). In some cases the Zn—Ni alloy also contains impurities. Here, the term “impurities” of the Zn—Ni alloy refers to substances other than Zn and Ni that are contained in the Zn—Ni alloy plating layer during production and the like of the oil-well metal pipe 1, and whose contents are within a range that does not influence the effects of the present embodiment.

Here, the Zn—Ni alloy plating layer contains Zn. Zn is a base metal in comparison to Fe. Therefore, the Zn—Ni alloy plating layer is corroded with priority relative to the steel material (sacrificial protection). In this way, the corrosion resistance property of the oil-well metal pipe 1 is improved.

The chemical composition of the Zn—Ni alloy plating layer can be measured by the following method. A sample including the Zn—Ni alloy plating layer (sample including a contact surface on which the Zn—Ni alloy plating layer is formed) is taken from the oil-well metal pipe 1. The Zn—Ni alloy plating layer of the obtained sample is dissolved in hydrochloric acid at 10% concentration to obtain a liquid solution. The obtained liquid solution is subjected to elemental analysis by Inductively Coupled Plasma Atomic Emission Spectrometry (ICP-AES), and the Ni content (mass %) and Zn content (mass %) in the Zn—Ni alloy plating layer are determined.

### [Thickness of Zn—Ni Alloy Plating Layer]

The thickness of the Zn—Ni alloy plating layer is not particularly limited. The thickness of the Zn—Ni alloy plating layer is, for example, 1 to 20 μm. If the thickness of the Zn—Ni alloy plating layer is 1 μm or more, the galling resistance can be further improved. Even if the thickness of the Zn—Ni alloy plating layer is more than 20 μm, the aforementioned effects will be saturated. The lower limit of the thickness of the Zn—Ni alloy plating layer is preferably 3 μm, and more preferably is 5 μm. The upper limit of the thickness of the Zn—Ni alloy plating layer is preferably 18 μm, and more preferably is 15 μm.

The thickness of the Zn—Ni alloy plating layer in the present embodiment can be measured by the following method. The thickness of the Zn—Ni alloy plating layer is measured at an arbitrary four locations on the pin contact surface 400 or the box contact surface 500 on which the Zn—Ni alloy plating layer is formed, using an eddy current phase-type coating thickness gauge PHASCOPE PMP10 manufactured by Helmut Fischer GmbH. The measurement is performed by a method conforming to ISO (International Organization for Standardization) 21968 (2005). The measurement locations are four locations (four locations at 0°, 90°, 180° and) 270° in the pipe circumferential direction of the oil-well metal pipe 1. The arithmetic mean value of the measurement results is taken as the thickness of the Zn—Ni alloy plating layer 100.

### [Zinc Phosphate Chemical Conversion Treatment Layer]

In the oil-well metal pipe 1 according to the present embodiment, a zinc phosphate chemical conversion treatment layer is formed on the Zn—Ni alloy plating layer 100. That is, in a case where the Zn—Ni alloy plating layer 100 is formed on the pin contact surface 400, a zinc phosphate chemical conversion treatment layer is formed on the Zn—Ni alloy plating layer 100 that is formed on the pin contact surface 400. In this case, on the box contact surface 500, the Zn—Ni alloy plating layer 100 may be formed, a zinc phosphate chemical conversion treatment layer may be formed, or neither the Zn—Ni alloy plating layer 100 nor a zinc phosphate chemical conversion treatment layer need be formed. Further, in a case where the Zn—Ni alloy plating layer 100 is formed on the box contact surface 500, a zinc phosphate chemical conversion treatment layer is formed on the Zn—Ni alloy plating layer 100 that is formed on the box contact surface 500. In this case, on the pin contact surface 400, the Zn—Ni alloy plating layer 100 may be formed, a zinc phosphate chemical conversion treatment layer may be formed, or neither the Zn—Ni alloy plating layer 100 nor a zinc phosphate chemical conversion treatment layer need be formed. That is, in the present embodiment, it suffices that the Zn—Ni alloy plating layer 100 is formed on at least either one of the pin contact surface 400 or the box contact surface 500, and a zinc phosphate chemical conversion treatment layer is formed on the Zn—Ni alloy plating layer 100 in question.

In the following description, the structure on the pin contact surface 400 in a case where a Zn—Ni alloy plating layer and a zinc phosphate chemical conversion treatment layer are formed on the pin contact surface 400, and the structure on the box contact surface 500 in a case where a Zn—Ni alloy plating layer and a zinc phosphate chemical conversion treatment layer are formed on the box contact surface 500 are described.

[Structure on Pin Contact Surface in Case where Zn—Ni Alloy Plating Layer is Formed on Pin Contact Surface]

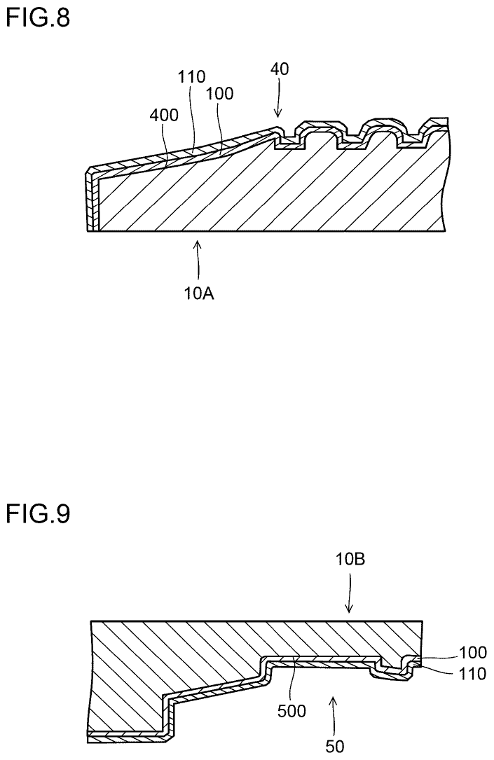

FIG. 8 is a cross-sectional view of the vicinity of the pin contact surface 400 in a case where a Zn—Ni alloy plating layer is formed on the pin contact surface 400. Referring to FIG. 8, the oil-well metal pipe 1 further includes the Zn—Ni alloy plating layer 100 that is formed on the pin contact surface 400 of the pin 40, and a zinc phosphate chemical conversion treatment layer 110 that is formed on the Zn—Ni alloy plating layer 100 in question.

The Zn—Ni alloy plating layer 100 may be formed on one part of the pin contact surface 400 or may be formed on the entire pin contact surface 400. The interfacial pressure increases, in particular, in the final stage of fastening at the pin sealing surface 42. Therefore, in a case where the Zn—Ni alloy plating layer 100 is partially formed on the pin contact surface 400, the Zn—Ni alloy plating layer 100 is preferably formed on at least the pin sealing surface 42. Further, the zinc phosphate chemical conversion treatment layer 110 is preferably formed on the entire Zn—Ni alloy plating layer 100.

[Structure on Box Contact Surface in Case where Zn—Ni Alloy Plating Layer is Formed on Box Contact Surface]

FIG. 9 is a cross-sectional view of the vicinity of the box contact surface 500 in a case where a Zn—Ni alloy plating layer is formed on the box contact surface 500. Referring to FIG. 9, the oil-well metal pipe 1 further includes the Zn—Ni alloy plating layer 100 that is formed on the box contact surface 500 of the box 50, and the zinc phosphate chemical conversion treatment layer 110 that is formed on the Zn—Ni alloy plating layer 100 in question.

The Zn—Ni alloy plating layer 100 may be formed on one part of the box contact surface 500 or may be formed on the entire box contact surface 500. The interfacial pressure increases, in particular, in the final stage of fastening at the box sealing surface 52. Therefore, in a case where the Zn—Ni alloy plating layer 100 is partially formed on the box contact surface 500, the Zn—Ni alloy plating layer 100 is preferably formed on at least the box sealing surface 52. Further, the zinc phosphate chemical conversion treatment layer 110 is preferably formed on the entire Zn—Ni alloy plating layer 100.

### [Orientation of Zinc Phosphate Chemical Conversion Treatment Layer]

In the oil-well metal pipe 1 according to the present embodiment, the orientation index X₀₂₀ of the (020) plane in the zinc phosphate chemical conversion treatment layer 110 is 2.00 or more. As mentioned above, in the present description the term “orientation index” refers to an index that indicates to what extent a specific plane is preferentially oriented in comparison to non-oriented zinc phosphate polycrystalline powder. That is, when the orientation index X₀₂₀ of the (020) plane of a zinc phosphate chemical conversion treatment layer is 2.00 or more, it means that the (020) plane is preferentially oriented by a multiple of 2.00 or more compared to a case of random orientation.

This point will now be described more specifically. In the oil-well metal pipe 1 according to the present embodiment, the Zn—Ni alloy plating layer 100 is formed as an underlayer relative to the zinc phosphate chemical conversion treatment layer 110. In this case, a chemical conversion treatment is performed on the Zn—Ni alloy plating layer 100 to form the zinc phosphate chemical conversion treatment layer 110. Further, as mentioned above, the chemical composition of the Zn—Ni alloy plating layer 100 contains zinc (Zn) and nickel (Ni), with the balance being impurities. Therefore, the zinc phosphate chemical conversion treatment layer 110 according to the present embodiment contains almost no zinc-iron phosphate crystals (Zn₂Fe(PO₄)₂·4H₂O: also referred to as “phosphophyllite”) which are generally contained in a zinc phosphate chemical conversion treatment layer, and is mainly composed of zinc phosphate crystals (Zn₃(PO₄)₂·4H₂O: also referred to as “hopeite”).

Here, the Miller indices of an arbitrary plane are represented as (hkl). In the zinc phosphate chemical conversion treatment layer 110 according to the present embodiment which is mainly composed of hopeite, diffraction lines detected by XRD have diffraction peaks of various crystals planes that are typified by the (020) plane, the (240) plane, the (241) plane and the (151) plane. Further, as mentioned above, the orientation index is an index that indicates to what extent the corresponding plane is preferentially oriented in comparison to non-oriented zinc phosphate polycrystalline powder. That is, in the present embodiment, the orientation index X₀₂₀ of the (020) plane of the zinc phosphate chemical conversion treatment layer 110 can be defined by the following Formula (1).

$$FORMULA 1$$

$${X}_{020} = \frac{\frac{{I}_{020}}{\sum {I}_{hkl}}}{\frac{{I}_{020}^{′}}{\sum {I}_{hkl}^{′}}} \qquad ( 1 )$$

Where, I₀₂₀, ΣIₕₖₗ, I′₀₂₀, and ΣI′ₕₖₗ in Formula (1) are defined as follows.
I₀₂₀: Diffraction intensity of (020) plane of zinc phosphate chemical conversion treatment layer 110
ΣIₕₖₗ: Sum of diffraction intensities of all crystal planes of zinc phosphate chemical conversion treatment layer 110
I′₀₂₀: Diffraction intensity of (020) plane of non-oriented zinc phosphate polycrystalline powder
ΣI′ₕₖₗ: Sum of diffraction intensities of all crystal planes of non-oriented zinc phosphate polycrystalline powder

That is, in the oil-well metal pipe 1 according to the present embodiment, the orientation index X₀₂₀ of the (020) plane defined by the above Formula (1) in the zinc phosphate chemical conversion treatment layer 110 is 2.00 or more. As a result, a large amount of unevenness is formed in the surface of the zinc phosphate chemical conversion treatment layer 110, and the adhesion of a lubricant coating formed on the zinc phosphate chemical conversion treatment layer 110 increases. It is considered that, in this way, the galling resistance of the oil-well metal pipe 1 according to the present embodiment increases.

In the present embodiment, the orientation index X₀₂₀ of the (020) plane of the zinc phosphate chemical conversion treatment layer 110 can be determined by the following method. A test specimen is prepared from the pin contact surface 400 or the box contact surface 500 on which the zinc phosphate chemical conversion treatment layer 110 is formed in the oil-well metal pipe 1 according to the present embodiment. The size of the test specimen is not particularly limited, and for example is 15 mm×15 mm with a thickness of 2 mm. The surface of the zinc phosphate chemical conversion treatment layer 110 of the test specimen is subjected to X-ray diffraction measurement using an X-ray diffractometer. The X-ray diffraction measurement can be performed according to a well-known method. The X-ray diffractometer is not particularly limited, and for example RINT-2500 manufactured by Rigaku Corporation can be used. Further, in the present embodiment, the X-ray diffractometer target is not particularly limited. For example, Co may be adopted as the X-ray diffractometer target (Co-Kα radiation). Note that, the X-ray diffraction measurement is preferably performed by specifying an arbitrary four locations or more on the specimen.

Respective diffraction peaks including the (020) plane, the (240) plane, the (241) plane and the (151) plane are identified from the X-ray diffraction spectra obtained by the X-ray diffraction measurement. The intensities (cps) of the identified diffraction peaks are respectively determined, and I₀₂₀ and ΣIₕₖₗ are calculated. In addition, numerical values described in 37-0465 of the ICDD (International Centre for Diffraction Data) database can be used as the X-ray diffraction intensities of the corresponding planes in non-oriented zinc phosphate polycrystalline powder to be substituted for I′₀₂₀ and ΣI′ₕₖₗ. The orientation index X₀₂₀ of the (020) plane of the zinc phosphate chemical conversion treatment layer 110 can be determined based on I₀₂₀, ΣIₕₖₗ, I′₀₂₀, and ΣI′ₕₖₗ obtained by the above method and the aforementioned Formula (1). Note that, in the case of performing X-ray diffraction measurement by specifying an arbitrary plurality of locations on a specimen, the arithmetic mean value of the obtained plurality of orientation indexes X₀₂₀ is defined as the orientation index X₀₂₀ of the (020) plane of the zinc phosphate chemical conversion treatment layer 110.

### [Lubricant Coating]

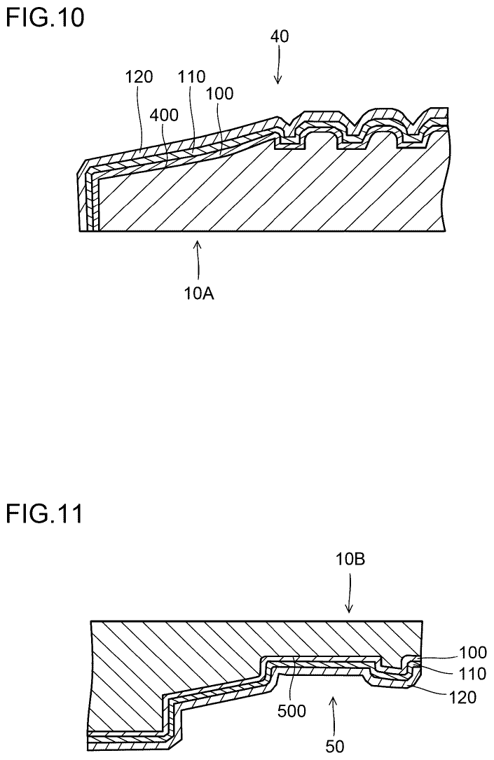

The oil-well metal pipe 1 may include a lubricant coating on the zinc phosphate chemical conversion treatment layer 110, or on a contact surface on which the Zn—Ni alloy plating layer 100 is not formed (on the pin contact surface 400 or on the box contact surface 500). The lubricant coating further enhances the lubricity of the oil-well metal pipe 1. Referring to FIG. 10, in a case where the Zn—Ni alloy plating layer 100 and the zinc phosphate chemical conversion treatment layer 110 are formed on the pin contact surface 400, a lubricant coating 120 may be formed on the zinc phosphate chemical conversion treatment layer 110. Further, referring to FIG. 11, in a case where the Zn—Ni alloy plating layer 100 and the zinc phosphate chemical conversion treatment layer 110 are formed on the box contact surface 500, the lubricant coating 120 may be formed on the zinc phosphate chemical conversion treatment layer 110.

The lubricant coating may be solid, or may be in a semi-solid state or a liquid state. The lubricant coating can be formed using a commercially available lubricant. The lubricant coating contains, for example, lubricating particles and a binder. As necessary, the lubricant coating may also contain a solvent and other components.

The lubricating particles are not particularly limited as long as they are particles having lubricity. The lubricating particles are, for example, one or more types selected from the group consisting of particles of graphite, MoS₂ (molybdenum disulfide), WS₂ (tungsten disulfide), BN (boron nitride), PTFE (polytetrafluoroethylene), CFx (graphite fluoride), and CaCO₃ (calcium carbonate).

The binder, for example, is one or two types selected from the group consisting of an organic binder and an inorganic binder. The organic binder is, for example, one or two types selected from the group consisting of a thermosetting resin and a thermoplastic resin. The thermosetting resin, for example, is one or more types selected from the group consisting of polyethylene resin, polyimide resin and polyamide-imide resin. The inorganic binder, for example, is one or two types selected from the group consisting of compounds containing alkoxysilane and siloxane bonds.

An example of a commercially available lubricant is SEAL-GUARD ECF (trade name) manufactured by JET-LUBE LLC. Other examples of the lubricant coating include a lubricant coating containing rosin, metallic soap, wax or a lubricant powder.

### [Method for Producing Oil-Well Metal Pipe 1]

A method for producing the oil-well metal pipe 1 according to the present embodiment is described hereunder. Note that, as long as the oil-well metal pipe 1 of the present embodiment has the structure described above, a method for producing the oil-well metal pipe 1 is not limited to the following production method. However, the production method described hereunder is one favorable example for producing the oil-well metal pipe 1 according to the present embodiment.

The method for producing the oil-well metal pipe 1 includes a preparation process (S1) of preparing a hollow shell in which the pin 40 or the box 50 is formed, a Zn—Ni alloy plating layer formation process (S2), and a zinc phosphate chemical conversion treatment process (S3). Hereunder, each process of the method for producing the oil-well metal pipe 1 of the present embodiment is described in detail.

### [Preparation Process (S1)]

In the preparation process (S1), a hollow shell in which the pin 40 or the box 50 is formed is prepared. In the present description, the phrase “hollow shell in which the pin or the box is formed” means either of the pipe main body 10 and the pin tube body 11 in a T&C type oil-well metal pipe 1 and the pipe main body 10 in the integral type oil-well metal pipe 1.

The hollow shell (pipe main body 10) in which the pin 40 or the box 50 is formed is produced, for example, by the following method. A starting material is produced using molten steel. Specifically, a cast piece (a slab, bloom or billet) is produced by a continuous casting process using the molten steel. An ingot may also be produced by an ingot-making process using the molten steel. As necessary, the slab, bloom or ingot may be subjected to blooming to produce a billet. The starting material (a slab, bloom or billet) is produced by the above described process. The prepared starting material is subjected to hot working to produce a hollow shell. The hot working method may be piercing-rolling by means of the Mannesmann process, or may be a hot-extrusion process. The hollow shell after hot working is subjected to well-known quenching and well-known tempering to adjust the strength of the hollow shell. A hollow shell is produced by the above process. Note that, in a case where the oil-well metal pipe 1 is the T&C type, a hollow shell for the coupling 12 is also prepared. The method for producing the hollow shell for the coupling 12 is the same as the method for producing the hollow shell that is described above.

In a case where the oil-well metal pipe 1 is the T&C type, threading is performed with respect to the outer surface of both end portions of the hollow shell for the pin tube body 11, to form the pin 40 that includes the pin contact surface 400. By means of the above process, a hollow shell (the pin tube body 11) in which the pin 40 is formed is prepared in a case where the oil-well metal pipe 1 is the T&C type. Note that, in a case where the oil-well metal pipe 1 is the T&C type, the coupling 12 may also be prepared. Specifically, threading is performed with respect to the inner surface of both end portions of the hollow shell for the coupling 12, to form the box 50 that includes the box contact surface 500. The coupling 12 is produced by the above process.

In a case where the oil-well metal pipe 1 is the integral type, threading is performed on the outer surface of the first end portion 10A of the hollow shell to form the pin 40 that includes the pin contact surface 400. In addition, threading is performed with respect to the inner surface of the second end portion 10B of the hollow shell to form the box 50 that includes the box contact surface 500. By means of the above process, in a case where the oil-well metal pipe 1 is the integral type, a hollow shell (pipe main body 10) in which the pin 40 and the box 50 are formed is prepared.

### [Other Optional Processes]

The preparation process (S1) of the present embodiment may further include a grinding process.

In the case of performing a grinding process in the preparation process (S1) according to the present embodiment, for example, a sandblasting treatment, and finishing by machine grinding are performed in the grinding process. The sandblasting treatment is a treatment in which a blast material (abrasive) is mixed with compressed air and the mixture is propelled onto the contact surface. Examples of the blast material include spherical shot material and angular grid material. The surface roughness of the contact surface can be increased by the sandblasting treatment. The sandblasting treatment can be carried out by a well-known method. For example, air is compressed by a compressor, and the blast material is mixed with the compressed air. The blast material may be composed of, for example, stainless steel, aluminum, ceramic material, or alumina. The sandblasting treatment conditions such as the propelling speed are not particularly limited, and can be appropriately adjusted according to well-known conditions.

The preparation process (S1) of the present embodiment may further include a plating layer formation process. As described above, the pipe main body 10 according to the present embodiment may include a plating layer. Specifically, for example, a Ni strike plating layer may be formed on the pin contact surface 400 and/or on the box contact surface 500.

In the case of forming a Ni strike plating layer in the preparation process (S1) according to the present embodiment, the Ni strike plating layer is formed by electroplating on the pin contact surface 400 and/or on the box contact surface 500. The Ni strike plating layer is an extremely thin undercoat plating layer, and increases the adhesion of the Zn—Ni alloy plating layer 100. Note that, the plating bath to be used in the Ni strike plating process is not particularly limited, and a well-known bath can be used. Further, the conditions for forming the Ni strike plating layer are not particularly limited, and can be appropriately adjusted and set.

### [Zn—Ni Alloy Plating Layer Formation Process (S2)]

In the Zn—Ni alloy plating layer formation process (S2), the Zn—Ni alloy plating layer 100 is formed by electroplating on the pin contact surface 400 and/or on the box contact surface 500, after the preparation process (S1). As mentioned above, the Zn—Ni alloy plating layer 100 may be formed directly on the pin contact surface 400, or the Zn—Ni alloy plating layer 100 may be formed directly on the box contact surface 500.

In the Zn—Ni alloy plating layer formation process (S2), the Zn—Ni alloy plating layer 100 is formed by electroplating using a well-known plating bath containing zinc ions and nickel ions. For example, a plating bath containing zinc ions: 1 to 100 g/L and nickel ions: 1 to 100 g/L can be used. Further, the counter anions to the zinc ions and nickel ions are not particularly limited. For example, chloride ions or sulfate ions may be used as counter anions. That is, in the Zn—Ni alloy plating layer formation process (S2) according to the present embodiment, a chloride bath or a sulfate bath may be used as the plating bath.

The conditions of the electroplating in the Zn—Ni alloy plating layer formation process (S2) are not particularly limited, and can be appropriately adjusted according to well-known conditions. The electroplating conditions are, for example, a plating bath pH of 1 to 10, a plating bath temperature of 10 to 60 °C, a current density of 1 to 100 A/dm², and a treatment time of 0.1 to 30 minutes. In the case of forming the Zn—Ni alloy plating layer 100 on the pin contact surface 400, the pin contact surface 400 is immersed in the aforementioned plating bath and electroplating is performed. Similarly, in the case of forming the Zn—Ni alloy plating layer 100 on the box contact surface 500, the box contact surface 500 is immersed in the aforementioned plating bath and electroplating is performed.

### [Zinc Phosphate Chemical Conversion Treatment Process (S3)]

In the zinc phosphate chemical conversion treatment process (S3), a zinc phosphate chemical conversion treatment is performed on the Zn—Ni alloy plating layer 100 to form the zinc phosphate chemical conversion treatment layer 110. As mentioned above, the zinc phosphate chemical conversion treatment may be performed on the Zn—Ni alloy plating layer 100 formed on the pin contact surface 400, or the zinc phosphate chemical conversion treatment may be performed on the Zn—Ni alloy plating layer 100 formed on the box contact surface 500.

Usually, in a zinc phosphate chemical conversion treatment, a surface conditioner is applied to the base metal, or the base metal is immersed in a surface conditioner. Because microcrystals of zinc phosphate are contained in the surface conditioner, a large number of nuclei for precipitation of zinc phosphate crystals are dispersed. Thus, by applying a surface conditioner in a zinc phosphate chemical conversion treatment, a dense film can be formed. On the other hand, a surface conditioner is not used in the zinc phosphate chemical conversion treatment process (S3) according to the present embodiment. Therefore, the zinc phosphate chemical conversion treatment according to the present embodiment can cause crystals to grow in a specific direction, and can thus make the orientation index X₀₂₀ of the (020) plane 2.00 or more. Further, as a result, the zinc phosphate chemical conversion treatment layer 110 in which zinc phosphate crystals are locally unevenly distributed and there is a large amount of unevenness in the surface can be formed.

That is, in the zinc phosphate chemical conversion treatment process (S3) according to the present embodiment, application of a surface conditioner which is usually applied is not performed, and a chemical conversion treatment is performed in which the Zn—Ni alloy plating layer 100 is immersed in a chemical conversion treatment solution, or a chemical conversion treatment solution is applied onto the Zn—Ni alloy plating layer 100. In the present embodiment, as a chemical conversion treatment solution, for example, a chemical conversion treatment solution containing 1 to 150 g/L of phosphate ions, 3 to 70 g/L of zinc ions, 1 to 100 g/L of nitrate ions, and 0 to 30 g/L of nickel ions can be used. In this case, the temperature of the chemical conversion treatment solution is for example, 20 to 100 °C. Note that, as other conditions of a chemical conversion treatment, well-known conditions can be used.

### [Other Processes]

The processes for producing the oil-well metal pipe 1 according to the present embodiment may include other processes. For example, a preconditioning treatment typified by sandblasting treatment may be performed. Further, for example, the production processes may include a process for forming a lubricant coating. Furthermore, for example, a chemical conversion treatment other than the zinc phosphate chemical conversion treatment may be performed. In this way, well-known production processes may be further carried out.

### [Film Formation Process]

As necessary, in the production method of the present embodiment, a process for forming the lubricant coating 120 (film formation process) may be performed. In other words, the film formation process is an optional process. In the film formation process, the lubricant coating 120 is formed on the Zn—Ni alloy plating layer 100, and/or on the zinc phosphate chemical conversion treatment layer 110, and/or on a contact surface (pin contact surface 400 or box contact surface 500) on which neither of the Zn—Ni alloy plating layer 100 nor the zinc phosphate chemical conversion treatment layer 110 is formed.

In the film formation process, a lubricant or a composition containing the components of the aforementioned lubricant coating 120 is applied. In this way, a lubricant coating can be formed. Note that, the application method is not particularly limited. Examples of the application method include spray coating, brushing, and immersion. When adopting spray coating as the application method, the composition or lubricant may be heated and then sprayed in a state in which the flowability has been increased. In this case, in addition, the composition or lubricant is then dried to form the lubricant coating 120.

The oil-well metal pipe 1 according to the present embodiment is produced by the processes described above. However, the production method described above is one example of a method for producing the oil-well metal pipe 1 according to the present embodiment, and a method for producing the oil-well metal pipe 1 is not limited to the production method described above. The oil-well metal pipe 1 according to the present embodiment may be produced by another method.

Hereunder, advantageous effects of the oil-well metal pipe of the present embodiment will be described more specifically by way of examples. The conditions adopted in the following examples are one example of conditions which are employed for confirming the workability and advantageous effects of the oil-well metal pipe of the present embodiment. Accordingly, the oil-well metal pipe of the present embodiment is not limited to this one example of the conditions.

### EXAMPLES

In the present examples, VAM21 (registered trademark) manufactured by Nippon Steel Corporation was used as the oil-well metal pipe. VAM21 (registered trademark) is an oil-well metal pipe having an external diameter of 244.48 mm (9⅝ inches) and a wall thickness of 13.84 mm. The steel grade corresponded to P110 according to the API 5CT standard.

The box contact surface of the oil-well metal pipe of each test number was subjected to a surface treatment that was configured differently to the surface treatments performed on the other test numbers. Hereunder, the box contact surface of each test number is described specifically.

### [Test Number 1]

In Test Number 1, a Zn—Ni alloy plating layer (described in the column “Underlayer” in Table 1) was formed on the box contact surface. In addition, a zinc phosphate chemical conversion treatment layer was formed on the Zn—Ni alloy plating layer. At this time, surface conditioning was not performed on the zinc phosphate chemical conversion treatment (described in the column “Zinc Phosphate Chemical Conversion Treatment Layer” in Table 1). Further, a lubricant coating was formed on the zinc phosphate chemical conversion treatment layer.

TABLE 1

| | | Zinc Phosphate | | Number of Times |
|---|---|---|---|---|
| Test | | Chemical Conversion | Orientation | of Making/Breaking |
| Number | Underlayer | Treatment Layer | Index X₀₂₀ | (times) |
| 1 | Zn—Ni alloy | No Surface Conditioning | 3.87 | 10 |
| | plating layer | Performed | | |
| 2 | Zn—Ni alloy | Surface Conditioning | 1.06 | 5 |
| | plating layer | Performed | | |
| 3 | Zn—Ni alloy | Not Formed | — | 3 |
| | plating layer | | | |

### [Test Number 2]

In Test Number 2, a Zn—Ni alloy plating layer (described in the column “Underlayer” in Table 1) was formed on the box contact surface. In addition, a zinc phosphate chemical conversion treatment layer was formed on the Zn—Ni alloy plating layer. At this time, surface conditioning was performed on the zinc phosphate chemical conversion treatment (described in the column “Zinc Phosphate Chemical Conversion Treatment Layer” in Table 1). Further, a lubricant coating of the same kind as in Test Number 1 was formed on the zinc phosphate chemical conversion treatment layer.

### [Test Number 3]

In Test Number 3, a Zn—Ni alloy plating layer (described in the column “Underlayer” in Table 1) was formed on the box contact surface. On the other hand, a zinc phosphate chemical conversion treatment layer was not formed on the Zn—Ni alloy plating layer (described in the column “Zinc Phosphate Chemical Conversion Treatment Layer” in Table 1). In addition, a lubricant coating of the same kind as in Test Numbers 1 and 2 was formed on the Zn—Ni alloy plating layer.

Note that, the Zn—Ni alloy plating layer formation conditions adopted in each test number were as follows. An electroplating treatment was performed on the box contact surface of each test number to form a Zn—Ni alloy plating layer. Specifically, a plating bath “DAIN Zinalloy N-PL” (trade name) manufactured by Daiwa Fine Chemicals Co., Ltd. was used as the Zn—Ni alloy plating bath. The electroplating conditions were set as follows: the pH of the plating bath was 6.5, the temperature of the plating bath was 25 °C, the current density was 2 A/dm², and the treatment time was 18 minutes. Note that, the plating bath contained Zn in an amount of 85%, and Ni in an amount of 15%.

Further, in Test Number 1, the zinc phosphate chemical conversion treatment layer formation conditions were as follows. Specifically, the Zn—Ni alloy plating layer of Test Number 1 was subjected to an alkaline degreasing treatment for 120 seconds. In addition, without being immersed in a surface conditioner, the Zn—Ni alloy plating layer was immersed in a zinc phosphate chemical conversion treatment solution. PALBOND SX35 (trade name) manufactured by Nihon Parkerizing Co., Ltd. was used as the zinc phosphate chemical conversion treatment solution. The treatment time was set to 300 seconds.

In addition, in Test Number 2, the zinc phosphate chemical conversion treatment layer formation conditions were as follows. Specifically, the Zn—Ni alloy plating layer of Test Number 2 was subjected to an alkaline degreasing treatment for 120 seconds. The Zn—Ni alloy plating layer was immersed in a surface conditioner for 30 seconds, which was followed by rinsing. After rinsing, the Zn—Ni alloy plating layer was immersed in a zinc phosphate chemical conversion treatment solution. The zinc phosphate chemical conversion treatment solution used was of the same kind as used in Test Number 1, and the treatment time was also the same as in Test Number 1.

The box contact surface of each test number was obtained by the method described above. An orientation index measurement test and a galling resistance test were performed using the obtained oil-well metal pipe including the pin contact surface and the box contact surface of each test number.

### [Orientation Index Measurement Test]

The zinc phosphate chemical conversion treatment layer formed above the box contact surface of each of Test Numbers 1 and 2 was subjected to XRD measurement by the aforementioned method to determine the orientation index X₀₂₀ of the (020) plane of the zinc phosphate chemical conversion treatment layer. Specifically, the zinc phosphate chemical conversion treatment layer of each of Test Numbers 1 and 2 was subjected to X-ray diffraction measurement using an X-ray diffractometer. RINT-2500 manufactured by Rigaku Corporation was used as the X-ray diffractometer. Further, Co was adopted as the target (Co-Kα radiation) in the X-ray diffraction measurement. Further, X-ray diffraction measurement was performed at an arbitrary four locations specified on the zinc phosphate chemical conversion treatment layer of each of Test Numbers 1 and 2.

Diffraction peaks corresponding to the (020) plane, (240) plane, (241) plane, and (151) plane were identified from the X-ray diffraction spectra obtained by the X-ray diffraction measurement. The intensities (cps) of the identified diffraction peaks were determined, and defined as I₀₂₀, I₂₄₀, and I₂₄₁. In addition, numerical values described in 06-0653 of the ICDD database were used as the X-ray diffraction intensities of the corresponding planes in non-oriented zinc phosphate polycrystalline powder to be substituted for I′₀₂₀, I′₂₄₀, and I′₂₄₁. The orientation index X₀₂₀ of the (020) plane of the relevant zinc phosphate chemical conversion treatment layer 110 was determined based on I₀₂₀, I₂₄₀, I₂₄₁, I′₀₂₀, I′₂₄₀, and I′₂₄₁ that were obtained by the above method, and the aforementioned Formula (1). The arithmetic mean value of the orientation indexes X₀₂₀ obtained at the respective measurement locations was adopted as the orientation index X₀₂₀ for the corresponding test number, and the value is shown in the column “Orientation Index X₀₂₀” in Table 1. Note that, in Test Number 3, since a zinc phosphate chemical conversion treatment layer was not formed, an orientation index measurement test was not performed.

### [Galling Resistance Test]

A galling resistance test was prepared and conducted in accordance with API Recommended Practice 5C5 (2017). Specifically, fastening was performed using a pin and a box of each test number until threads intermeshed at an initial stage of fastening by hand tightening (state in which fastening is performed by human power). After the threads were fastened by hand tightening, fastening and loosening using a power tong were repeated, and the galling resistance was evaluated. Each time one cycle of fastening and loosening was completed, the pin contact surface and the box contact surface were observed by visual observation. The state of occurrence of galling was checked by visual inspection. If the galling was minor and was repairable, the galling flaws were corrected and the test was continued. The number of times that fastening and loosening could be performed without unrepairable galling occurring was measured. The number of times fastening and loosening were performed obtained as a result is shown in the column “Number of Times of Making/Breaking (times)” in Table 1.

### [Evaluation Results]

Referring to Table 1, in the oil-well metal pipe of Test Number 1, the orientation index X₀₂₀ of the (020) plane of the zinc phosphate chemical conversion treatment layer was 2.00 or more. As a result, the number of times of making/breaking was 10 times, and thus excellent galling resistance was exhibited.

On the other hand, in the oil-well metal pipe of Test Number 2, the orientation index X₀₂₀ of the (020) plane of the zinc phosphate chemical conversion treatment layer was less than 2.00. As a result, the number of times of making/breaking was five times, and thus excellent galling resistance was not exhibited.

In the oil-well metal pipe of Test Number 3, a zinc phosphate chemical conversion treatment layer was not formed. As a result, the number of times of making/breaking was three times, and thus excellent galling resistance was not exhibited.

An embodiment of the present disclosure has been described above. However, the foregoing embodiment is merely an example for implementing the present disclosure. Accordingly, the present disclosure is not limited to the above embodiment, and the above embodiment can be appropriately modified within a range which does not deviate from the gist of the present disclosure.

### REFERENCE SIGNS LIST

1 Oil-well Metal Pipe
10 Pipe Main Body
10A First End Portion
10B Second End Portion
40 Pin
41 External Thread Part
50 Box
51 Internal Thread Part
100 Zn—Ni Alloy Plating Layer
110 Zinc Phosphate Chemical Conversion Treatment Layer
111 Zinc Phosphate Crystals
120 Lubricant Coating
400 Pin Contact Surface
500 Box Contact Surface

1. An oil-well metal pipe, comprising:
a pipe main body including a first end portion and a second end portion;
wherein
the pipe main body includes:
a pin formed at the first end portion, and
a box formed at the second end portion;
the pin includes:
a pin contact surface including an external thread part; and
the box includes:
a box contact surface including an internal thread part;
the oil-well metal pipe further comprising:
a Zn—Ni alloy plating layer formed on the pin contact surface and/or on the box contact surface, and
a zinc phosphate chemical conversion treatment layer formed on the Zn—Ni alloy plating layer;
wherein, in the zinc phosphate chemical conversion treatment layer, an orientation index X₀₂₀ of a (020) plane is 2.00 or more.

2. The oil-well metal pipe according to claim 1, comprising:
a lubricant coating on the zinc phosphate chemical conversion treatment layer.
